(19) United States
(12) Patent Application Publication
(10) Pub. No.: US 2026/0139170 A1
(43) Pub. Date: May 21, 2026

(54) MOISTURE AND HEAT-CURABLE SEALING COMPOSITION

(71) Applicant: SIKA TECHNOLOGY AG, Baar (CH)

(72) Inventors: Fangyuan LIU, Suzhou (CN); Elyes JENDOUBI, Tokyo (JP); Weiming ZHANG, Suzhou (CN)

(73) Assignee: SIKA TECHNOLOGY AG, Baar (CH)

(21) Appl. No.: 19/119,137

(22) PCT Filed: Nov. 29, 2022
(86) PCT No.: PCT/CN2022/134935

§ 371 Date: Apr. 8, 2025

(51) Int. Cl. C09J 175/04; C08G 59/40; C08G 59/68; C08K 3/04; C08K 3/22; C08K 3/26; C08K 3/36; C08K 5/3417; C09J 5/00

(52) U.S. Cl. CPC C09J 175/04; C08G 59/4021; C08G 59/4042; C08G 59/685; C08K 3/04; C08K 3/36; C08K 5/3417; C09J 5/00; C08K 2003/2206; C08K 2003/265; C08K 2201/001

(57) ABSTRACT

A sealing composition, including: at least one epoxy terminated polyurethane prepolymer; heat-activatable curing agent or accelerator including an amidoamine having a primary amino group and dicyanodiamide; impact modifier which is a reaction product of at least one polymeric diol, at least one polyisocyanate, and cardanol; and at least one polyaldimine. The sealing compound composition is suitable for use as a sealing compound in automotive bodies.

### TECHNICAL FIELD

The invention relates to the field of a sealing composition for automotive body work in particular.

### PRIOR ART

In automotive body work, individual metal plates are joined together. The metal plates that are used are oiled to reduce corrosion as much as possible. Furthermore, typically, the vehicle body will be passed through a CDC bath (CDC=cathodic dip coating) at the end of assembly of the body, so that the body is coated with a so-called CDC paint, which is then baked in a CDC oven. Good CDC coating over the full surface area forms the basis for long-term use of a vehicle because it makes a significant contribution toward corrosion resistance.

Therefore, usually on these oiled metal plates like steel substrates are usually coated a sealer which is required to adhere well to oil-coated sheet metal, need not be cured with heat or UV radiation before being immersed in a paint bath and nevertheless rapidly build up strength.

WO 2012/084806 provides a heat-curable sealing compound compositions having a dual curing mechanism. On the one hand, there is rapid formation of a skin due to the reaction of polyisocyanates with polyaldimines in contact with air and/or atmospheric humidity; this ensures that the sealing compound can pass through the CDC bath undamaged. The paint may be deposited on the sealing compound in a high-quality application. In another step, the sealing compound cures due to heat such as that prevailing in the CDC oven.

However, there is in some cases a bubble formation problem in these sealers. Besides, the adhesion on the oiled metal plates still needs to be increased so as to meet more demanding requirements in the manufacture.

### SUMMARY OF THE INVENTION

The object of the present invention is therefore to make available a single-component sealing composition which has improved adhesion to oil-coated sheet metal and less bubble formation, for example no bubble in applied bead after 1-2 days at room temperature or within 30 min at 180° C. In the meantime, the sealing composition still maintain good mechanical and storage properties as well as rapid strength build-up.

It has surprisingly been found that the moisture and heat curable sealing composition according to claim 1 achieve this object.

The sealing compound composition is therefore suitable for use as a sealing compound in automotive bodies in particular.

Additional aspects of the invention are the subject matter of further independent claims. Especially preferred embodiments of the invention are the subject matter of the dependent claims.

### Methods of Implementing the Invention

The present invention relates to a moisture and heat curable sealing composition, which comprises:
at least one epoxy terminated polyurethane prepolymer (A);
heat-activatable curing agent or accelerator (B) comprising an amidoamine having a primary amino group and dicyanodiamide;
impact modifier (I) which is a reaction product of at least one polymeric diol, at least one polyisocyanate, and cardanol; and
at least one polyaldimine (PA).

The term “polymer” in the present document refers on the one hand to a group of macromolecules that are chemically uniform but are different with respect to the degree of polymerization, the molecular weight and the chain length and are synthesized by a polyreaction (polymerization, polyaddition, polycondensation). On the other hand, this term also includes derivatives of such a group of macromolecules from polyreactions, i.e., compounds obtained by reactions, for example, addition or substitution of functional groups on predetermined molecules and which may be chemically uniform or chemically heterogeneous. This term additionally also includes so-called prepolymers, i.e., reactive oligomeric precursors whose functional groups are involved in the structure of the macromolecules.

The term “polyurethane polymer” includes all polymers synthesized by the so-called diisocyanate polyaddition process. This also includes polymers which are almost or entirely free of urethane groups. Examples of polyurethane polymers include polyether polyurethanes, polyester polyurethanes, polyether polyureas, polyureas, polyester polyureas, polyisocyanurates and polycarbodiimides (Houben Weyl “Methoden der organischen Chemie [Methods of Organic Chemistry],” Thieme Verlag, Stuttgart 1987, Vol. E20, page 1561).

Substance names that begin with “poly-” such as polyisocyanate, polyaldimine, polyamine, polyol, polymercaptans or polyglycidyl ethers in the present document refer to substances formally containing two or more functional groups, which also appear in their name, per molecule.

All industry standards mentioned in this document relate to the version valid at the date of first filing, unless specified otherwise.

The terms “mass” and “weight” are used synonymously in this document. Thus a “percentage by weight” (% by weight) is a percentage mass fraction which unless otherwise stated relates to the mass (the weight) of the total composition or, depending on the context, of the entire molecule.

The term “molecular weight” in the present document, in the context of polymers, refers to the average molecular weight Mn, commonly measured with gel permeation chromatography (GPC) against polystyrene standard.

Room temperature of the present documents is understood to be a temperature of 25° C.

The term “vehicle” in this document is understood to refer to any means of transport by water, by land and by air. Such means of transport include in particular ships, wheeled vehicles, such as automobiles, buses, cars, trucks and rail vehicles such as streetcars and railway vehicles.

The term “primary amino group” in the present document refers to an amino group in the form of an NH₂ group bound to an organic radical. Consequently, a “primary amine” is a molecule having a primary amino group.

The term “secondary amino group” denotes an amino group in which the nitrogen atom is bound to two organic radicals which together may also be part of a ring. Consequently, a “secondary amine” is a molecule which has a secondary amino group.

The term “tertiary amino group” denotes an amino group in which the nitrogen atom is bound to three organic radicals, such that two of these radicals together may also be part of a ring (=tertiary amine nitrogen). Consequently, a “tertiary amine” is a molecule which has a tertiary amino group.

“Aliphatic” refers to an amine or an amino group, in which the nitrogen atom is bound exclusively to aliphatic, cycloaliphatic or araliphatic radicals.

The term “epoxide group” or “epoxy group” is understood to refer to the structural element

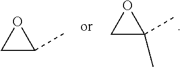

“Glycidyl ether” refers to an ether of 2,3-epoxy-1-propanol (glycidol).

The dashed lines in the formulas in this document in each case represent the bond between the respective substituent and the respective molecular radical.

The moisture and heat-curable sealing composition is a single-component composition.

A “single-component” composition in the present document denotes a curable composition in which all the ingredients of the composition are mixed and stored together in the same container and which are stable in storage over a lengthy period of time at room temperature, so they undergo little or no significant change in their use properties or application properties due to storage, and such a composition cures following application by the action of moisture and/or heat.

The at least one epoxy terminated polyurethane prepolymer (A) used in the inventive moisture and heat curable composition refers to an isocyanate group containing polyurethane prepolymer which is partly terminated by the epoxide and thus still has a certain content of free isocyanate group, preferably between 0.8 and 3.0% by weight, preferably between 1.0 and 2.5% by weight, more preferably between 1.5 and 2.0% by weight of free NCO groups, based on the total weight of the polyurethane prepolymer (A). Therefore, the epoxy terminated polyurethane polymer used here is distinct from a simple mixture of an epoxy resin with an isocyanate group containing polyurethane prepolymer.

It is advantageous in the inventive moisture and heat curable composition that the at least one epoxy terminated polyurethane prepolymer (A) is used in an amount of 35-60 wt %, preferably 40-55 wt %.

In one embodiment, the epoxy terminated polyurethane prepolymer (A) may be represented by the following formula (IVa):

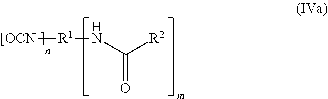

where R¹ is a linear or branched polyurethane prepolymer PU1 terminated by n+m isocyanate groups, after removal of all of the terminal isocyanate groups;
each R², independently of the others, is a group of the formula (II)

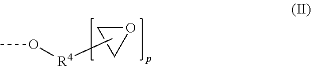

where in each case R⁴ is a moiety of an aliphatic, cycloaliphatic, aromatic, or araliphatic epoxide containing a primary or secondary hydroxy group, after the removal of the hydroxide and epoxide groups;
p=1, 2, or 3;
each of n and m is a value from 1 to 7, with the proviso that 2≤(m+n)≤8.

The polyurethane prepolymer PU1 on which R¹ is based can be produced from at least one diisocyanate or triisocyanate, or else from a polymer Q_{PM} having terminal amino, thiol, or hydroxy groups, and/or from a polyphenol Q_{PP}, if appropriate having substitution.

Suitable diisocyanates are aliphatic, cycloaliphatic, aromatic, or araliphatic diisocyanates, in particular commercially available products, such as methylene-diphenyl diisocyanate (MDI), hexamethylene diisocyanate (HDI), toluene diisocyanate (TDI), tolidine diisocyanate (TODI), isophorone diisocyanate (IPDI), trimethylhexamethylene diisocyanate (TMDI), 2,5- or 2,6-bis(isocyanatomethyl) bicyclo[2.2.1]heptane, naphthalene 1,5-diisocyanate (NDI), dicyclohexylmethyl diisocyanate (H₁₂MDI), p-phenylene diisocyanate (PPDI), m-tetramethylxylylene diisocyanate (TMXDI), etc., and also their dimers. Preference is given to HDI, IPDI, MDI or TDI.

Suitable triisocyanates are trimers or biurets of aliphatic, cycloaliphatic, aromatic, or araliphatic diisocyanates, in particular the isocyanurates and biurets of the diisocyanates described in the previous paragraph.

It is, of course, also possible to use suitable mixtures of di- or triisocyanates.

Particularly suitable polymers Q_{PM} having terminal amino, thiol, or hydroxy groups are polymers Q_{PM} having two or three terminal amino, thiol, or hydroxy groups.

The polymers Q_{PM} advantageously have an equivalent weight of from 300 to 6000, in particular from 600 to 4000, preferably from 700 to 2200, g/equivalent of NCO-reactive groups.

Suitable polymers Q_{PM} are polyols, such as the following commercially available polyols, or any desired mixtures thereof:
polyoxyalkylene polyols, also termed polyether polyols, where these are the polymerization product of ethylene oxide, propylene 1,2-oxide, butylene 1,2- or 2,3-oxide, tetrahydrofuran, or a mixture thereof, if appropriate polymerized with the aid of a starter molecule having two or three active H atoms, examples being water or compounds having two or three OH groups. The materials used can either be polyoxyalkylene polyols which have a low degree of unsaturation (measured according to ASTM D2849-69 and stated in milliequivalent of unsaturation per gram of polyol (mEq/g)), produced by way of example with the aid of what are known as double metal cyanide complex catalysts (abbreviated to DMC catalysts), or else polyoxyalkylene polyols having a higher degree of unsaturation, produced by way of example with the aid of anionic catalysts, such as NaOH, KOH, or alkali metal alcoholates. Particularly suitable materials are polyoxypropylenediols and -triols having a degree of unsaturation below 0.02 mEq/g and having a molecular weight in the range from 1000 to 30 000 daltons, polyoxybutylenediols and -triols, polyoxypropylenediols and -triols having a molecular weight of from 400 to 8000 daltons, and also the materials termed “EO-endcapped” (ethylene-oxide-endcapped) polyoxypropylenediols or -triols. The latter are specific polyoxy-propylene polyoxyethylene polyols obtained by, for example, using ethylene oxide to alkoxylate pure polyoxypropylene polyols after conclusion of the polypropoxylation reaction, so that the products have primary hydroxy groups;
hydroxy-terminated polybutadiene polyols, such as those produced via polymerization of 1,3-butadiene and allyl alcohol or via oxidation of polybutadiene, and also their hydrogenation products;
styrene-acrylonitrile-grafted polyether polyols, such as those supplied as Lupranol® by Elastogran;
polyhydroxy-terminated acrylonitrile/butadiene copolymers such as those obtainable from carboxy-terminated acrylonitrile/butadiene copolymers (available commercially as Hycar® CTBN from Nanoresins AG, Germany) and from epoxides or amino alcohols;
polyester polyols produced by way of example from di- to trihydric alcohols, such as 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane, or a mixture of the abovementioned alcohols, using organic dicarboxylic acids or their anhydrides or esters, examples being succinic acid, glutaric acid, adipic acid, suberic acid, sebacic acid, dodecanedicarboxylic acid, maleic acid, fumaric acid, phthalic acid, isophthalic acid, terephthalic acid, and hexahydrophthalic acid, or a mixture of the above-mentioned acids, and also polyester polyols derived from lactones, such as ε-caprolactone;
polycarbonate polyols, such as those obtainable via reaction, for example, of the abovementioned alcohols—used in the structure of the polyester polyols—with dialkyl carbonates, with diaryl carbonates, or with phosgene.

The polymers Q_{PM} are advantageously at least dihydric polyols having OH-equivalent weights of from 300 to 6000 g/OH-equivalent, in particular from 600 to 4000 g/OH-equivalent, preferably from 700 to 2200 g/OH-equivalent. Further advantageous polyols are those selected from the group consisting of polyethylene glycols, polypropylene glycols, polyethylene glycol-polypropylene glycol block copolymers, polybutylene glycols, hydroxy-terminated polybutadienes, hydroxy-terminated butadiene/acrylonitrile copolymers, hydroxy-terminated synthetic rubbers, their hydrogenation products, and mixtures of the abovementioned polyols.

Other polymers Q_{PM} that can also be used are at least difunctional amino-terminated polyethylene ethers, polypropylene ethers, such as those marketed as Jeffamine® by Huntsman, polybutylene ethers, polybutadienes, butadiene/acrylonitrile copolymers such as those marketed as Hycar® ATBN by Nanoresins AG, Germany, and also other amino-terminated synthetic rubbers or mixtures of the components mentioned.

For certain applications, particularly suitable polymers Q_{PM} are hydroxylated polybutadienes or polyisoprenes, or their partially or completely hydrogenated reaction products.

It is moreover possible that the polymers Q_{PM} can also have been chain-extended, in the manner known to the person skilled in the art, via the reaction of polyamines, polyols, and polyisocyanates, in particular of diamines, diols, and diisocyanates.

For the chain extension reaction, particular preference is given to diols and/or diamines and diisocyanates. The person skilled in the art is, of course, aware that it is also possible to use higher-functionality polyols, such as trimethylolpropane or pentaerythritol, or higher-functionality polyisocyanates, such as isocyanurates of diisocyanates, for the chain extension reaction.

In the case of the polyurethane prepolymers PU1 generally, and in the case of the chain-extended polyurethane prepolymers specifically, it is advantageous to ensure that the prepolymers do not have excessive viscosities, particularly if higher-functionality compounds are used for the chain extension reaction, because this can create difficulties in their reaction to give the polymers of the formula (IVa), or in the application of the composition.

Preferred polymers Q_{PM} are polyols having molecular weights of from 600 to 6000 daltons, selected from the group consisting of polyethylene glycols, polypropylene glycols, polyethylene glycol-polypropylene glycol block polymers, polybutylene, glycols, hydroxy-terminated polybutadienes, hydroxy-terminated butadiene-acrylonitrile copolymers, and also their mixtures.

Particularly preferred polymers Q_{PM} are α,ω-dihydroxypolyalkylene glycols having C₂-C₆-alkylene groups or having mixed C₂-C₆-alkylene groups, and having termination by amino, thiol, or, preferably, hydroxy groups. Particular preference is given to polypropylene glycols or polybutylene glycols. Particular preference is further given to polyoxybutylenes terminated by hydroxy groups.

Bis-, tris-, and tetraphenols are particularly suitable as polyphenol Q_{PP}. This not only means unsubstituted phenols but also, if appropriate, means substituted phenols. The nature of the substitution can be very varied. This in particular means substitution directly on the aromatic ring bonded to the phenolic OH group. Phenols here are moreover not only mononuclear aromatics but are also polynuclear or condensed aromatics or heteroaromatics, which have the phenolic OH group directly on the aromatic or heteroaromatic system.

The nature and position of this type of substituent is one of the factors influencing the reaction with isocyanates necessary for the formation of the polyurethane prepolymer PU1.

The bis- and trisphenols are particularly suitable. Examples of suitable bisphenols or trisphenols are 1,4-dihydroxybenzene, 1,3-dihydroxybenzene, 1,2-dihydroxybenzene, 1,3-dihydroxytoluene, 3,5-dihydroxybenzoates, 2,2-bis(4-hydroxyphenyl) propane (=bisphenol A), bis(4-hydroxyphenyl)methane (=bisphenol F), bis(4-hydroxyphenyl) sulfone (=bisphenol S), naphthoresorcinol, dihydroxynaphthalene, dihydroxyanthraquinone, dihydroxybiphenyl, 3,3-bis(p-hydroxyphenyl) phthalides, 5,5-bis(4-hydroxyphenyl) hexahydro-4,7-methanoindane, phenolphthaleine, fluorescein, 4,4′-[bis(hydroxyphenyl)-1,3-phenylenebis(1-methylethylidene)] (=bisphenol M), 4,4′-[bis(hydroxyphenyl)-1,4-phenylenebis(1-methylethylidene)] (=bisphenol P), 2,2′-diallylbisphenol A, diphenols and dicresols produced via reaction of phenols or of cresols with diisopropylidenebenzene, phloroglucinol, gallic esters, phenol novolac, respectively, cresol novolac having OH-functionality of from 2.0 to 3.5, and also all of the isomers of the abovementioned compounds.

In a first embodiment, the polyurethane prepolymer PU1 is produced from at least one diisocyanate or triisocyanate, and also from a polymer Q_{PM} having terminal amino, thiol, or hydroxy groups. The polyurethane prepolymer PU1 is produced in a manner known to the person skilled in the art of polyurethanes, in particular by using the diisocyanate or triisocyanate in a stoichiometric excess, based on the amino, thiol, or hydroxy groups of the polymer Q_{PM}.

In a second embodiment, the polyurethane prepolymer PU1 is produced from at least one diisocyanate or triisocyanate and also from a polyphenol Q_{PP}, which, if appropriate, has substitution. The polyurethane prepolymer PU1 is produced in a manner known to the person skilled in the art of polyurethanes, in particular by using the diisocyanate or triisocyanate in a stoichiometric excess, based on the phenolic groups of the polyphenol Q_{PP}.

In a third embodiment, the polyurethane prepolymer PU1 is produced from at least one diisocyanate or triisocyanate, and also from a polymer Q_{PM} having terminal amino, thiol, or hydroxy groups, and also from a polyphenol Q_{PP} which, if appropriate, has substitution. Various possibilities are available for production of the polyurethane prepolymer PU1 from at least one diisocyanate or triisocyanate, and also from a polymer Q_{PM} having terminal amino, thiol, or hydroxy groups, and/or from a polyphenol Q_{PP} which, if appropriate, has substitution.

The partly epoxy terminated polyurethane prepolymer of the formula (IVa) can be produced from the reaction of a polyurethane prepolymer PU1 having isocyanate groups and having the formula (III),

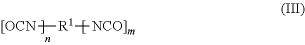

with an appropriate amount of a monohydroxyepoxide compound of the formula (V).

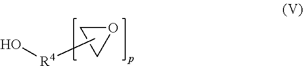

The monohydroxyepoxide compound of the formula (V) has 1, 2, or 3 epoxide groups. The hydroxy group of this monohydroxyepoxide compound (V) can be a primary or secondary hydroxy group.

These monohydroxyepoxide compounds can by way of example be produced via reaction of polyols with epichlorohydrin. As a function of the conduct of the reaction of polyhydric alcohols with epichlorohydrin, the corresponding monohydroxyepoxide compounds are also produced as by-products at various concentrations. These can be isolated via conventional separation operations.

However, it is generally possible simply to use the product mixture obtained in the glycidylization reaction of polyols and composed of polyol reacted completely or partially to give the glycidyl ether. Examples of these hydroxylated epoxides are butanediol monoglycidyl ether (present in butanediol diglycidyl ether), hexanediol monoglycidyl ether (present in hexanediol diglycidyl ether), cyclohexanedimethanol glycidyl ether, trimethylolpropane diglycidyl ether (in the form of mixture present in trimethylolpropane triglycidyl ether), glycerol diglycidyl ether (in the form of mixture present in glycerol triglycidyl ether), pentaerythritol triglycidyl ether (in the form of mixture present in pentaerythritol tetraglycidyl ether). It is preferable to use trimethylolpropane diglycidyl ether, a relatively high proportion of which occurs in conventionally produced trimethylolpropane triglycidyl ether.

However, it is also possible to use other similar hydroxylated epoxides, in particular glycidol, 3-glycidyloxybenzyl alcohol, or hydroxymethylcyclohexene oxide. Preference is further given to the β-hydroxy ether of the formula (IX), which is present to an extent of about 15% in commercially available liquid epoxy resins produced from bisphenol A (R=CH₃) and epichlorohydrin, and also the corresponding β-hydroxy ethers of the formula (IX) which are formed during the reaction of bisphenol F(R=H) or of the mixture of bisphenol A and bisphenol F with epichlorohydrin.

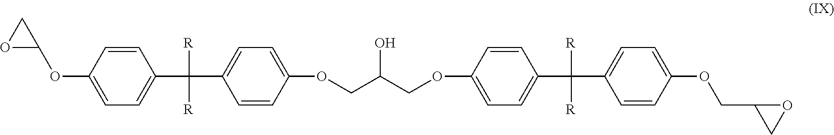

Preference is also further given to distillation residues produced during the production of high-purity, distilled liquid epoxy resins. These distillation residues have from one to three times higher concentration of hydroxylated epoxides when compared with commercially available undistilled liquid epoxy resins. It is also possible below to use a very wide variety of epoxides having a β-hydroxy ether group, produced via the reaction of (poly) epoxides with a substoichiometric amount of monofunctional nucleophiles, such as carboxylic acids, phenols, thiols, or secondary amines.

The free primary or secondary OH-functionality of the monohydroxyepoxide compound of the formula (V) permits efficient reaction with terminal isocyanate groups of prepolymers, without any need here to use disproportionate excesses of the epoxide component.

It is important to include the inventive moisture and heat curable sealing composition a heat-activatable curing agent or accelerator (B) comprising an amidoamine having a primary amino group and dicyanodiamide.

The amidoamine having a primary amino group is preferably the one that can be obtained by the reaction of phthalic anhydride and a polyamine having primary amino groups, in particular diethylene triamine (DETA) or triethylene tetramine (TETA).

It is possible for the dicyanodiamide to be present in a finely divided form and to have an average particle size of <12 μm, in particular from 1 to 10 μm, preferably between 5 and 9 μm. The particle size is determined here by means of a screen.

It has been found by the inventor that use of the specific combination of an amidoamine having a primary amino group with dicyanodiamde as a heat-activatable curing agent or accelerator in the inventive sealing composition may result in a significantly improvement in terms of the adhesion to the oiled plate and the mechanical properties after curing.

It is advantageous that the heat-activatable curing agent or accelerator (B) comprises 1.0-3.3 wt %, preferably 1.5-3.0 wt % of an amidoamine having a primary amino group and 0.05-0.8 wt %, preferably 0.12-0.55 wt % of a dicyanodiamide, each based on the total weight of the sealing composition. It has been found that less than 0.05 wt % of a dicyanodiamide in the composition may probably result in an excessively low tensile strength while higher than 0.8 wt % may probably impair the elongation at break too much. By using the required amount of a dicyanodiamide in combination with an amidoamine having a primary amino group, the overall mechanical properties can be well balanced.

The impact modifier (I) which is required in the inventive curable composition is a reaction product of at least one polymeric diol, at least one polyisocyanate, and cardanol.

In this reaction, the polymeric diol is preferably reacted in a first step with the polyisocyanate in order to yield an isocyanate-functional polyurethane prepolymer. The isocyanate groups of said polyurethane prepolymer are then preferably endcapped with cardanol in order to yield the final impact modifier I. Said impact modifier I preferably contains no more isocyanate groups in measurable amounts. In particular, it is preferred that at least 75%, in particular at least 90%, preferably at least 99% of all remaining isocyanate groups of said prepolymer are endcapped with cardanol after reaction.

The isocyanate group-containing prepolymer for impact modifier I is obtained, in particular, from the reaction of at least one monomeric polyisocyanate, in particular diisocyanate, and at least one suitable diol. The reaction is preferably carried out with exclusion of moisture at a temperature in the range from 20 to 160° C., in particular from 40 to 140° C., if appropriate in the presence of suitable catalysts.

The NCO/OH ratio is preferably in the range of 1.1/1 to 10/1, preferably 1.3/1 to 10/1. The monomeric polyisocyanate remaining in the reaction mixture after the reaction of the OH groups can be removed, in particular by means of distillation.

In the event that excess monomeric polyisocyanate is removed by distillation, the NCO/OH ratio in the reaction is preferably in the range from 3/1 to 10/1, in particular 4/1 to 7/1, and the resulting isocyanate group-containing prepolymer after the distillation preferably contains at most 0.5% by weight, particularly preferably at most 0.3% by weight, of monomeric polyisocyanate.

In the event that no excess monomeric polyisocyanate is removed from the prepolymer, the NCO/OH ratio in the reaction is preferably in the range from 1.3/1 to 2.5/1. Such a prepolymer contains in particular at most 3% by weight, preferably at most 2% by weight, of monomeric polyisocyanate.

Preferred impact modifiers I are a polymer of the formula (IV).

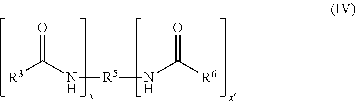

In this formula, x and x′ independently of one another are each values of 0 or 1, preferably 1, with the provision that at least one, preferably both of x and x′ are not 0;
R⁵ is a linear polyurethane prepolymer containing at least x+x′ terminal isocyanate groups, after removal of x+x′ terminal isocyanate groups;
R⁶ and R³ are residues of cardanol after removal of the hydroxyl H atom and are bonded via the oxygen atom.

Cardanol (CAS registry number: 37330-39-5) is a phenolic lipid obtained from anacardic acid, the main component of cashew nutshell liquid (CNSL), a byproduct of cashew nut processing. The name of the substance is derived by contraction from the genus Anacardium, which includes the cashew tree, Anacardium occidentale. The structure is shown in formula (X).

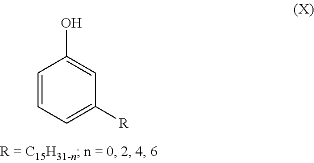

The name cardanol is used for the decarboxylated derivatives obtained by thermal decomposition of any of the naturally occurring anacardic acids. This includes more than one compound because the composition of the side chain varies in its degree of unsaturation. Tri-unsaturated cardanol, the major component (41%) is shown below in formula (VI). The remaining cardanol is 34% mono-unsaturated, 22% bi-unsaturated, and 2% saturated.

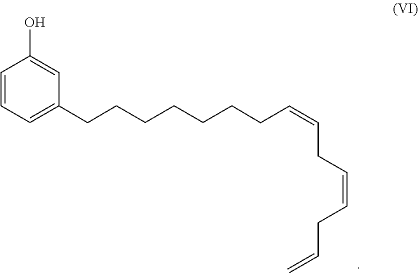 [SMILES: C=CC/C=C\C/C=C\CCCCCCCc1cccc(O)c1]

The phenolic OH group of cardanol readily reacts with the isocyanate groups of the isocyanate-functional prepolymer to yield impact modifier I.

It is noteworthy and surprising that cardanol is the only phenolic reagent that can be used in production of the impact modifier I of the present invention. Other, similar phenolic reagents, in particular nonylphenol, do not lead to an impact modifier with the same beneficial properties as impact modifier I.

Furthermore, cardanol has the advantage of being based on natural, renewable resources and it is inexpensive.

Cardanol is commercially available, for example under the trade name Cardolite® NC-700 by Cardolite Corporation.

In the process for preparing prepolymer that is endcapped by cardanol to produce impact modifier I, at least one polymeric diol is used. Suitable polymeric diols are especially those mentioned above suitable for preparing the polyurethane prepolymer.

Preferred diols are polyoxyalkylene diols, polyester diols, polycarbonate diols, polybutadiene diols, and poly(meth)acrylate diols. Among those, particularly preferred are polyether diols, in particular polypropylene glycol diols and polytetrahydrofuran diols.

Particular preference is given firstly to, in particular room temperature liquid, polyoxypropylenediols and polyoxyethylene-polyoxypropylene codiols, especially polyoxypropylenediols having a mean molecular weight in the range from 300 to 15′000 g/mol, in particular 1′000 to 10′000 g/mol, preferably from 2′000 to 5′500 g/mol. Particular preference is given to such diols with an average OH functionality in the range of 1.5 to 2.5, preferably 1.8 to 2.3.

Particular preference is further given to room temperature liquid or solid, amorphous or semicrystalline or crystalline diols, especially polyesterpolyols and polycarbonate diols, especially polyesterdiols having a mean molecular weight in the range from 300 to 15′000 g/mol, in particular 1′000 to 10′000 g/mol, preferably 1′500 to 8000 g/mol, especially 2′000 to 5′500 g/mol. Particularly suitable are adipic acid/hexanediol polyesters and crystalline or semicrystalline dodecanedicarboxylic acid/hexanediol polyesters.

Particular preference is further given to polybutadiene diols with an average OH functionality in the range of 1.5 to 2.5, preferably 1.8 to 2.3, and an average molar mass in the range of 300 to 15′000 g/mol, in particular 1′000 to 10′000 g/mol, preferably 1′500 to 8000 g/mol, more preferably 2000 to 4000 g/mol, especially 2500 to 3000 g/mol.

Such polybutadiene polyols are especially obtainable by the polymerization of 1,3-butadiene and allyl alcohol in a suitable proportion or by the oxidation of suitable polybutadienes.

Suitable polybutadiene polyols are especially polybutadiene diols containing structural elements of formula (VII) and optionally structural elements of formulas (VIII) and (IX).

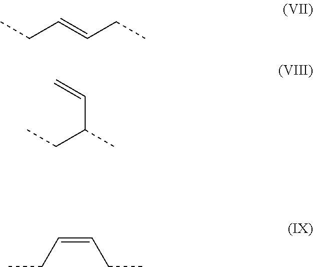

Preferred polybutadiene diols contain 40 to 80%, especially 55 to 65% of the structural element of formula (VII), 0 to 30%, especially 15 to 25%, of the structural element of formula (VIII), 0 to 30%, especially 15 to 25%, of the structural element of formula (IX).

Particularly suitable polybutadiene polyols are, for example, available form Cray Valley under the trade name range Poly bd®.

Most preferred of all diols for the synthesis of impact modifier I are, in particular liquid at room temperature, polyoxypropylenediols and polyoxyethylene-polyoxypropylene codiols, especially polyoxypropylenediols having a mean molecular weight in the range from 300 to 15′000 g/mol, in particular 1′000 to 10′000 g/mol, preferably from 2′000 to 5′500 g/mol. With these diols, especially high impact peel strengths can be obtained.

Thus, in the most preferred embodiments, said diol is a polyoxypropylenediol or a polyoxyethylene-polyoxypropylene copolymer diol, especially a polyoxypropylenediol having a mean molecular weight in the range from 300 to 15′000 g/mol, in particular 1′000 to 10′000 g/mol, preferably from 2′000 to 5′500 g/mol. Particular preference is given to such diols with an average OH functionality in the range of 1.5 to 2.5, preferably 1.8 to 2.3.

In the process for preparing prepolymer that is endcapped by cardanol to produce impact modifier I, at least one polyisocyanate, preferably diisocyanate is used.

Suitable polyisocyanates are especially monomeric di- or triisocyanates, as well as oligomers, polymers and derivatives of the monomeric di- or triisocyanates, as well as arbitrary mixtures thereof. These polyisocyanates may be those mentioned above for preparing the polyurethane prepolymer.

Suitable diisocyanates are especially commercially available aliphatic, cycloaliphatic, arylaliphatic and aromatic, preferably cycloaliphatic and aromatic, diisocyanates.

Preferred diisocyanates are hexamethylene 1,6-diisocyanate (HDI), 2,2,4- and 2,4,4-trimethylhexamethylene 1,6-diisocyanate (TMDI), cyclohexane 1,3- and 1,4-diisocyanate and any desired mixtures of these isomers, 1-isocyanato-3,3,5-trimethyl-5-isocyanatomethylcyclohexane (=isophorone diisocyanate or IPDI), perhydrodiphenylmethane 2,4′- and 4,4′-diisocyanate (HMDI), m- and p-xylylene diisocyanate (m- and p-XDI), m- and p-tetramethylxylylene 1,3- and 1,4-diisocyanate (m- and p-TMXDI), tolylene 2,4- and 2,6-diisocyanate (TDI) and any desired mixtures of these isomers, diphenylmethane 4,4′-, 2,4′- and 2,2′-diisocyanate and any desired mixtures of these isomers (MDI).

More preferably, the diisocyanate is selected from the group consisting of HDI, IPDI, MDI and TDI. These diisocyanates are particularly readily obtainable.

Particularly preferred as the polyisocyanate, in particular diisocyanate, are forms of MDI that are liquid at room temperature. These are especially so-called polymeric MDI as well as MDI with fractions of oligomers or derivatives thereof. The MDI (=4,4′-, 2,4′- or 2,2′-diphenylmethane diisocyanate and arbitrary mixtures of these isomers) contents of such liquid forms of MDI amounts, in particular, to 50 to 95 wt.-%, especially 60 to 90 wt.-%.

Particularly preferred as the polyisocyanate are polymeric MDI and MDI types that are preferably liquid at room temperature, which contain fractions of MDI-carbodiimides or adducts thereof.

Most preferred polyisocyanate for the synthesis of impact modifier I is 4,4′-, 2,4′- and 2,2′-diphenylmethane diisocyanate and arbitrary mixtures of these isomers (MDI), mixtures of MDI and MDI homologs (polymeric MDI or PMDI), in particular forms that are liquid at room temperatures, as well as MDI with fractions of oligomers or derivatives thereof. The MDI (=4,4′-, 2,4′- or 2,2′-diphenylmethane diisocyanate and arbitrary mixtures of these isomers) contents of such liquid forms of MDI amounts, in particular, to 50 to 95 wt.-%, especially 60 to 90 wt.-%.

Thus, in most preferred embodiments, said polyisocyanate is 4,4′-, 2,4′- or 2,2′-diphenylmethane diisocyanate and arbitrary mixtures of these isomers (MDI). Impact modifiers I based on MDI allow for especially high impact peel strengths.

Impact modifier (I) preferably has an apparent epoxy equivalent weight of >500 g/eq, in particular >1000 g/eq, preferably >1500 g/eq, in particular >2000 g/eq.

It is found advantageous if the impact modifier (I) is contained in an amount of 1-25 wt %, preferably 3-15 wt %, based on the total weight of the sealing composition. Less than 1 wt % of the impact modifier (I) may probably weaken the elongation at break while higher than 25 wt % may probably impair the tensile strength.

Polyaldimines (PA) can be synthesized from polyamines (PAM) with two or more primary amino groups and aldehydes.

Suitable polyamines (PAM) having two or more primary amino groups that are suitable in particular include:
aliphatic, cycloaliphatic or araliphatic diamines, for example, ethylenediamine, 1,2-propanediamine, 1,3-propanediamine, 2-methyl-1,2-propanediamine, 2,2-dimethyl-1,3-propanediamine, 1,3-butanediamine, 1,4-butanediamine, 1,3-pentanediamine (DAMP), 1,5-pentanediamine, 1,5-diamino-2-methylpentane (MPMD), 1,6-hexanediamine, 2,5-dimethyl-1,6-hexanediamine, 2,2,4- and 2,4,4-trimethylhexamethylenediamine (TMD), 1,7-heptanediamine, 1,8-octanediamine, 1,9-nonanediamine, 1,10-decanediamine, 1,11-undecanediamine, 1,12-dodecanediamine, and methyl-bis-(3-aminopropyl)amine, 1,2-, 1,3- and 1,4-diaminocyclohexane, bis-(4-aminocyclohexyl)methane, bis-(4-amino-3-methylcyclohexyl)methane, bis-(4-amino-3-ethylcyclohexyl)methane, bis-(4-amino-3,5-dimethylcyclohexyl)methane, bis-(4-amino-3-ethyl-5-methylcyclohexyl)methane (M-MECA), 1-amino-3-aminomethyl-3,5,5-trimethylcyclohexane (=isophoronediamine or IPDA), 2- and 4-methyl-1,3-diaminocyclohexane and mixtures thereof, 1,3- and 1,4-bis-(aminomethyl)cyclohexane, 2,5 (2,6)-bis-(aminomethyl) bicyclo[2.2.1]heptane (NBDA), 3 (4),8 (9)-bis-(aminomethyl)tricyclo-[5.2.1.02,6]decane, 1,4-diamino-2,2,6-trimethylcyclohexane (TMCDA), 3,9-bis-(3-aminopropyl)-2,4,8,10-tetraoxaspiro[5.5]undecane as well as 1,3- and 1,4-xylylenediamine;
aliphatic diamines containing ether groups, for example, bis-(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine and higher oligomers of these diamines, bis-(3-aminopropyl) polytetrahydrofurans and other polytetrahydrofuran diamines having molecular weights in the range of, for example, 350 to 5200 as well as polyoxyalkylenediamines. The latter are typically products of the amination of polyoxyalkylenediols and can be obtained, for example, under the name Jeffamine® (from Huntsman Chemicals), under the name polyether amine (from BASF) or under the name PC Amine® (from Nitroil). Especially suitable polyoxyalkylenediamines include Jeffamine® D-230, Jeffamine® D-400, Jeffamine® D-2000, Jeffamine® D-4000, Jeffamine® XTJ-511, Jeffamine® ED-600, Jeffamine® ED-900, Jeffamine® ED-2003, Jeffamine® XTJ-568, Jeffamine® XTJ-569, Jeffamine® XTJ-523, Jeffamine® XTJ-536, Jeffamine® XTJ-542, Jeffamine® XTJ-559, polyether amine D 230, polyether amine D 400 and polyether amine D 2000, PC Amine® DA 250, PC Amine® DA 400, PC Amine® DA 650 and PC Amine® DA 2000;
aliphatic triamines such as 4-aminomethyl-1,8-octane diamine, 1,3,5-tris(aminomethyl)benzene, 1,3,5-tris-(aminomethyl)cyclohexane:
primary polyoxyalkylene triamines, which are typically the products of the amination of polyoxyalkylenetriols and can be obtained, for example, under the brand name Jeffamine® (from Huntsman Chemicals), under the name polyether amine (from BASF) or under the name PC Amine® (from Nitroil) such as for example, Jeffamine® T-403, Jeffamine® T-5000; polyether amine T 403, polyether amine T 5000; and PC Amine® TA 403, PC Amine® TA 5000.

Preferred polyamines (PAM) include polyamines selected from the group consisting of 1,6-hexamethylenediamine, MPMD, DAMP, IPDA, TMD, 1,3-xylylenediamine, 1,3-bis-(aminomethyl)cyclohexane, bis-(4-aminocyclo-hexyl)methane, bis-(4-amino-3-methyl-cyclohexyl)methane, 3 (4),8 (9)-bis-(aminomethyl)tricyclo-[5.2.1.0^{2,6}]decane, 1,2-, 1,3- and 1,4-diaminocyclohexane, 1,4-diamino-2,2,6-trimethylcyclohexane, 3,6-dioxaoctane-1,8-diamine, 4,7-dioxadecane-1,10-diamine, 4-aminomethyl-1,8-octane diamine and polyoxyalkylene polyamines having two or three amino groups, in particular the products D-230, D-400, D-2000, T-403 and T-5000 from Huntsman that are available under the brand name Jeffamine® as well as similar compounds from BASF or Nitroil as well as mixtures of the polyamines mentioned above. The diamines mentioned above are especially preferred polyamines (PAM).

Essentially any aldehydes are suitable as said aldehydes. These aldehydes may be aliphatic, cycloaliphatic, arylaliphatic or aromatic aldehydes and may be monoaldehydes or polyaldehydes.

It has been found that it is advantageous if the polyaldimine (PA) does not have a hydrogen atom on the carbon atom in a-position to the carbon of the aldimino group. Such aldimines cannot form any tautomeric forms (enamine)-in contrast with aldimines which have hydrogen atoms in a-position to the carbon (see formula diagram below):

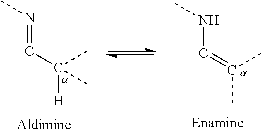

It has been found that compositions which are especially stable in storage can be obtained with such polyaldimines which do not have hydrogen atoms in a-position.

Such polyaldimines can be synthesized from polyamines (PAM) having two or more primary amino groups according to the formula and aldehydes of formula (II′) or (III′)

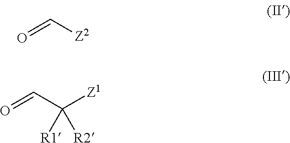

where R1′ and R2′, independently of one another, each stand for a monovalent hydrocarbon radical having 1 to 12 carbon atoms or R1′ and R2′ together stand for a divalent hydrocarbon radical having 4 to 12 carbon atoms that is part of an optionally substituted carbocyclic ring having 5 to 8 carbon atoms, preferably 6 carbon atoms.

In addition, Z¹ stands for a monovalent hydrocarbon radical having 1 to 32 carbon atoms, optionally having at least one heteroatom, in particular oxygen in the form of ether, carbonyl or ester groups or in particular nitrogen in the form of tertiary amino groups.

In addition Z² stands either for a substituted or unsubstituted aryl or heteroaryl group which has a ring size of 5 to 8 atoms, preferably 6 atoms or for

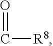

wherein R⁸ stands for a hydrogen atom or for an alkoxy group or for a substituted or unsubstituted alkenyl or arylalkenyl group having at least 6 carbon atoms.

Examples of such aldehydes of formula (II′) include aromatic aldehydes such as benzaldehyde, 2- and 3- and 4-tolualdehyde, 4-ethyl, 4-propyl, 4-isopropyl and 4-butyl benzaldehyde, 2,4-dimethyl benzaldehyde, 2,4,5-trimethyl benzaldehyde, 4-acetoxy benzaldehyde, 4-anisaldehyde, 4ethoxy benzaldehyde, the isomeric di- and trialkoxy benzaldehydes, 2-, 3- and 4-nitrobenzaldehyde, 2-, 3- and 4-formyl pyridine, 2-furfuraldehyde, 2-thiophene carbaldehyde, 1- and 2-naphthyl aldehyde, 3- and 4-phenyloxy benzaldehyde, quinoline 2-carbaldehyde and its 3-, 4-, 5-, 6-, 7- and 8-positional isomers as well as anthracene 9-carbaldehyde and also glyoxal, glyoxalic acid esters such as glyoxalic acid methyl ester, cinnamaldehyde and substituted cinnamaldehydes.

Examples of aldehydes of formula (III′) include for example pivalaldehyde (=2,2-dimethylpropanal), 2,2-dimethylbutanal, 2,2-diethylbutanal, 1-methylcyclopentane carboxaldehyde, 1-methylcyclohexane carboxaldehyde, 2,2-dimethyl-3-phenylpropanal and 2,2-dimethyl-3-p-toluylpropanal; ethers of 2-hydroxy-2-methylpropanal and alcohols such as propanol, isopropanol, butanol and 2-ethylhexanol; esters of 2-formyl-2-methylpropionic acid or 3-formyl-3-methylbutyric acid and alcohols such as propanol, isopropanol, butanol and 2-ethylhexanol; esters of 2-hydroxy-2-methylpropanal and carboxylic acids such as butyric acid, isobutyric acid and 2-ethylhexanoic acid; as well as ethers and esters of 2,2-disubstituted 3-hydroxypropanals, butanals or similar higher aldehydes, in particular 2,2-dimethyl-3-hydroxypropanal as well as the aldehydes of formula (IV′) that are described below as being especially suitable.

Polyaldimines of formula (l′) have proven to be especially suitable,

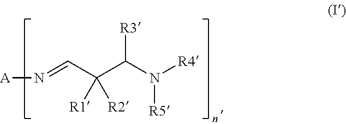

where A′ stands for the radical of an amine after removal of n primary aliphatic amino groups, said radical not containing any active hydrogen atoms. In addition, n stands for 2 or 3 or 4 or 5, preferably for 2 or 3. Furthermore, either R1′ and R2′, independently of one another, each stands for a monovalent hydrocarbon radical having 1 to 12 carbon atoms or R1′ and R2′ together stand for a divalent hydrocarbon radical having 4 to 12 carbon atoms, which is part of an optionally substituted carbocyclic ring having 5 to 8 carbon atoms, preferably 6 carbon atoms.
R3′ stands for a hydrogen atom or an alkyl group or an aralkyl group or an alkoxycarbonyl group, in particular having 1 to 12 carbon atoms.

Either R4′ and R5′, independently of one another, each stands for a monovalent aliphatic, cycloaliphatic or araliphatic radical having 1 to 20 carbon atoms, optionally containing heteroatoms in the form of ether oxygen or tertiary amine nitrogen, or R4′ and R5′ together stand for a divalent aliphatic radical having 3 to 20 carbon atoms, which is part of an optionally substituted heterocyclic ring having 5 to 8 ring atoms, preferably 6 ring atoms, wherein this ring also contains, in addition to the nitrogen atom, other heteroatoms in the form of ether oxygen or tertiary amine nitrogen.

In addition, to synthesize an aldimine of formula (l′), at least one sterically hindered aliphatic aldehyde (ALD) of formula (IV′) is used:

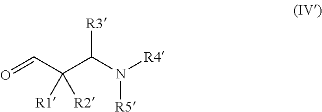

wherein R1′, R2′, R3′, R4′ and R5′ have the meanings already given above. R1′ and R2′ preferably each stand for a methyl group and R3′ preferably stands for a hydrogen atom.

R4′ and R5′ preferably, independently of one another, each stand for methyl, ethyl, propyl, isopropyl, butyl, 2-ethylhexyl, cyclohexyl or benzyl or together-including the nitrogen atom-they form a ring, in particular a pyrrolidine, piperidine, morpholine or N-alkylpiperazine ring, where this ring is optionally substituted.

Aldehydes (ALD) of formula (IV′) can be obtained in particular as the product of a Mannich reaction or an α-aminoalkylation analogous to the Mannich reaction as is known from the technical literature and which may therefore also be referred to Mannich bases. An aldehyde (Y1) of formula (V′), an aldehyde (Y2) of formula (VI′) and a secondary aliphatic amine (C) of formula (VII′) are reacted here, with elimination of water, to form an aldehyde (ALD)

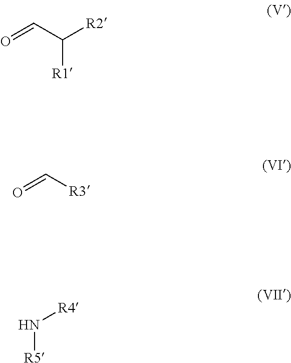

wherein R1′, R2′, R3′, R4′ and R5′ have the meanings already given above.

This reaction may be performed either with the free reagents, i.e., the aldehyde of formula (V′) (Y1), the aldehyde of formula (VI′) (Y2) and the amine (C) or the reagents may be used in a partially or completely derivatized form. Thus the aldehyde (Y1) may be used as an enolate, as an enol ether, in particular as a silylenol ether, or as an enamine. The aldehyde (Y2) may be used, for example, in the form of an oligomer—in particular in the case of formaldehyde as 1,3,5-trioxane or as paraformaldehyde—or as a hydrate, hemiacetal, acetal, N, O-acetal, aminal or hemiaminal. Finally, the secondary aliphatic amine (C) may be used in the form of a salt, in particular as an amine hydrochloride or as an amine hydrosulfate or as a silylamine. It is possible to use a portion of the reagents in free form and a portion in derivatized form or to use them only in derivatized forms. When using reagents in derivatized form, the aldehyde (ALD) is also obtained in derivatized form, for example, as a salt under some circumstances. In this case, it may be converted to the free form according to formula (IV′) by suitable workup. It may be appropriate to additionally use additives such as Lewis acids or catalysts in such conversion reactions, depending on the conditions.

In addition, the reaction may be carried out as a one-pot reaction, in which all three reagents can react with one another at the same time; or a stepwise procedure may be selected by reacting first two of the reagents with one another and then reacting the resulting intermediate with the third reagent, where the intermediate may or may not be isolated. Such intermediates that are suitable include in particular iminium salts, which are obtained from the reaction of an aldehyde (Y2) in free or derivatized form with a salt of a secondary aliphatic amine (C) and which can be reacted with an aldehyde (Y1) in free or derivatized form to form the corresponding salt of an aldehyde (ALD) of formula (IV′). Such a stepwise procedure may be advantageous in permitting milder reaction conditions and thus giving a higher product yield.

In addition, the reaction may take place using solvents, in particular polar solvents such as water or alcohols, or the reaction may be performed without using solvents.

In a preferred specific embodiment, the reaction is carried out as a one-pot reaction with all the reagents in free form and the aldehyde (ALD) is purified by distillation after completing the reaction. It is preferable not to use any organic solvents.

For example, the following aldehydes are suitable as the aldehyde (Y1) of formula (V′): isobutyraldehyde, 2-methylbutyraldehyde, 2-ethylbutyraldehyde, 2-methylvaleraldehyde, 2-ethylcaproaldehyde, cyclopentane carboxaldehyde, cyclohexanecarboxaldehyde, 1,2,3,6-tetrahydrobenzaldehyde, 2-methyl-3-phenylpropionaldehyde, 2-phenylpropionaldehyde and diphenylacetaldehyde. Isobutyraldehyde is preferred.

Suitable examples of the aldehyde (Y2) of formula (VI′) include the following aldehydes: formaldehyde, acetaldehyde, propionaldehyde, butyraldehyde, isobutyraldehyde, phenylacetaldehyde, benzaldehyde and substituted benzaldehydes as well as glyoxylic acid esters, in particular glyoxylic acid ethyl esters. Formaldehyde is preferred.

Examples of suitable amines (C) of formula (VII′) include the following secondary aliphatic amines: dimethylamine, diethylamine, dipropylamine, diisopropylamine, dibutylamine, diisobutylamine, di-sec-butylamine, dihexylamine, di-(2-ethylhexyl)amine, dicyclohexylamine, N-methylbutylamine, N-ethylbutylamine, N-methyl cyclohexylamine, N-ethyl cyclohexylamine, di-2-methoxyethylamine, pyrrolidine, piperidine, N-methylbenzylamine, N-isopropylbenzylamine, N-tert-butyl benzylamine, dibenzylamine, morpholine, 2,6-dimethylmorpholine, bis-(3-dimethylaminopropyl)amine, N-methyl or N-ethyl-piperazine.

Preferred examples of the amine (C) include dimethylamine, diethylamine, diisopropylamine, dibutylamine, diisobutylamine, N-methylcyclohexylamine, N-methyl benzylamine, N-isopropyl benzylamine, N-tert-butylbenzylamine, dibenzylamine, pyrrolidine, piperidine, morpholine, 2,6-dimethylmorpholine, N-methyl- and N-ethyl piperazine.

The aldehyde (ALD) is preferably synthesized by the reaction of isobutyraldehyde as the aldehyde (Y1) of the formula (V′), formaldehyde as the aldehyde (Y2) of formula (VI′) and one of the amines selected from the group consisting of dimethylamine, diethylamine, diisopropylamine, dibutylamine, diisobutylamine, N-methylcyclohexylamine, N-methylbenzylamine, N-isopropylbenzylamine, N-tert-butylbenzylamine, dibenzylamine, pyrrolidine, piperidine, morpholine, 2,6-dimethylmorpholine, N-methyl- and N-ethylpiperazine as the amine (C) of formula (VII′).

Preferred aldehydes (ALD) include 2,2-dimethyl-3-dimethyl aminopropanal, 2,2-dimethyl-3-diethyl aminopropanal, 2,2-dimethyl-3-dibutyl-aminopropanal, 2,2-dimethyl-3-(N-pyrrolidino) propanal, 2,2-dimethyl-3-(N-piperidino) propanal, 2,2-dimethyl-3-(N-morpholino) propanal, 2,2-dimethyl-3-(N-(2,6-dimethyl)-morpholino) propanal, 2,2-dimethyl-3-(N-(4-methylpiperazino)) propanal, 2,2-dimethyl-3-(N-(4-ethylpiperazino)) propanal, 2,2-dimethyl-3-(N-benzylmethyl-amino) propanal, 2,2-dimethyl-3-(N-benzylisopropylamino) propanal and 2,2-dimethyl-3-(N-cyclohexylmethylamino) propanal. The preferred aldehydes (ALD) have a comparatively low basicity.

Aldimines of formula (l′) can be synthesized directly from polyamines (PAM) having two or more primary amino groups and aldehydes (ALD) of formula (IV′), as already described above, by reacting a polyamine (PAM) with an aldehyde (ALD) in a condensation reaction with the removal of water.

It has been found that when using polyaldimines of formula (l′), an improved storage stability of the heat-curing sealant composition can be achieved.

In one preferable embodiment, the polyaldimines (PA) may be a dialdimine of the formula (XI)

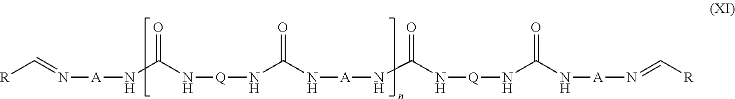

in which R represents the radical of an aldehyde ALD after removal of an aldehyde group;
A represents the radical of a diamine DA having two primary aliphatic amino groups after removal of the two primary aliphatic amino groups;
Q represents the radical of a diisocyanate DI after removal of both isocyanate groups; z represents 0 or represents an integer from 1 to 15; and
in which A and R have no groups which are reactive with isocyanate groups in the absence of water.

The more details on the preparation and application of diamine of the formula (XI) may be referred to CN101616891A, which is incorporated into the description with its entirety.

Polyaldimine (PA) is typically used in an amount between 0.3% and 10% by weight, in particular between 0.5% and 5% by weight, preferably between 1% and 3% by weight, based on the weight of the heat-curing sealant composition.

In addition, the polyaldimine (PA) is preferably present in the sealant composition in an amount such that the ratio of the number of aldimino groups to the number of isocyanate groups has a value of 0.2 to 0.8, in particular of 0.3 to 0.7.

The inventive sealing composition described here may contain additional ingredients as needed. In particular these include fillers (F), reactive diluents, catalysts, stabilizers, in particular heat and/or light stabilizers, thixotropy agents, plasticizers, solvents, blowing agents, dyes and pigments, corrosion preventing agents, surfactants, foam suppressants, and adhesion promoters.

The fillers (F) are preferably mica, talc, kaolin, wollastonite, feldspar, syenite, chlorite, bentonite, montmorillonite, calcium carbonate (chalk, precipitated or ground), dolomite, quartz, silicic acids (pyrogenic or precipitated), cristobalites, calcium oxide, aluminum hydroxide, magnesium oxide, ceramic hollow beads, glass hollow beads, organic hollow beads, glass beads, carbon black, graphite, metal powder, ground electrically conductive polymers or colored pigments.

It is especially preferable for the sealing composition to contain carbon black or other electrically conductive additives, in particular graphite, metal powder or ground electrically conductive polymers as the filler. These lead to a certain conductivity of the sealing compound composition in coating by means of a CDC paint, and this in turn has an advantageous effect on coating results.

Suitable fillers (F) include both the organically coated and the uncoated forms that are available commercially and are known to those skilled in the art.

The total amount of total fillers (F) is preferably 3-50% by weight, especially 5-35% by weight, in particular 5-25% by weight, based on the weight of the total composition.

In one preferred embodiment, the sealing composition additionally contains the reactive diluents which may be the reactive diluents (G) containing epoxy groups.

The reactive diluents (G) containing epoxy groups include in particular:
glycidyl ethers of monofunctional saturated or unsaturated branched or unbranched cyclic or open-chain C₄ to C₃₀ alcohols, in particular selected from the group consisting of butanol glycidyl ether, hexanol glycidyl ether, 2-ethylhexanol glycidyl ether, allyl glycidyl ether, tetrahydrofurfuryl and furfuryl glycidyl ether, trimethoxysilyl glycidyl ether.
glycidyl ethers of difunctional saturated or unsaturated branched or unbranched cyclic or open-chain C₂ to C₃₀ alcohols, in particular selected from the group consisting of ethylene glycol, butanediol, hexanediol, octanediol glycidyl ether, cyclohexane dimethanol diglycidyl ether and neopentyl glycol diglycidyl ether.
glycidyl ethers of tri- or polyfunctional saturated or unsaturated branched or unbranched cyclic or open-chain alcohols such as epoxidized castor oil, epoxidized trimethylolpropane, epoxidized pentaerythritol or polyglycidyl ethers of aliphatic polyols such as sorbitol, glycerol or trimethylolpropane.
glycidyl ethers of phenol and aniline compounds, in particular selected from the group consisting of phenyl glycidyl ether, cresyl glycidyl ether, p-tert-butylphenylglycidyl ether, nonylphenol glycidyl ether, 3-n-pentadecenyl glycidyl ether (from cashew nut shell oil), N,N-diglycidylaniline and triglycidyl of p-aminophenol.
epoxidized amines such as N,N-diglycidyl cyclohexylamine.
epoxidized mono- or dicarboxylic acids, in particular selected from the group consisting of neodecanoic acid glycidyl ester, methacrylic acid glycidyl ester, benzoic acid glycidyl ester, phthalic acid, tetra- and hexahydrophthalic acid diglycidyl ester and diglycidyl esters of dimeric fatty acids as well as terephthalic acid and trimellitic acid glycidyl ester;
epoxidized di- or trifunctional low- to high-molecular polyether polyols, in particular polyethylene glycol diglycidyl ethers or polypropylene glycol diglycidyl ethers.

Hexanediol diglycidyl ether, cresyl glycidyl ether, p-tert-butylphenyl glycidyl ether, polypropylene glycol diglycidyl ether and polyethylene glycol diglycidyl ether are especially preferred.

The total amount of the reactive diluent (G) containing epoxy groups is advantageously 0.1-20% by weight, preferably 1-8% by weight, based on the weight of the total composition.

In another especially preferred embodiment, the sealing composition additionally contains at least one catalyst (KA) which accelerates the hydrolysis of aldimino groups. Such catalysts (KA) include in particular acids, for example, organic carboxylic acids such as benzoic acid, salicylic acid or 2-nitrobenzoic acid, organic carboxylic anhydrides such as phthalic anhydride, hexahydrophthalic anhydride and hexahydromethyl phthalic anhydride, silyl esters of organic carboxylic acids, organic sulfonic acids such as methanesulfonic acid, p-toluenesulfonic acid or 4-dodecylbenzenesulfonic acid, sulfonic acid esters, other organic or inorganic acids or mixtures of the acids and acid esters mentioned above. Salicylic acid or 2-nitrobenzoic acid is most preferably used as the catalyst (KA).

In addition, it is especially advantageous if the sealing composition additionally contains at least one catalyst (KN) which accelerates the reaction of the isocyanate groups. Such catalysts (KN) that accelerate the reaction of isocyanate groups include in particular organotin compounds such as dibutyltin diacetate, dibutyltin dilaurate, dibutyltin dichloride, dibutyltin diacetylacetonate and dioctyltin dilaurate, bismuth compounds such as bismuth trioctoate and bismuth tris-neodecanoate and compounds containing tertiary amino groups such as 2,2′-dimorpholinodiethyl ether and 1,4-diazabicyclo[2.2.2]octane.

In addition, it is especially advantageous if the sealing composition additionally contains at least one rheology modifier (R). Such rheology modifiers (R) include in particular thickeners or thixotropy agents, for example, urea compounds, polyamide waxes, bentonites or pyrogenic silicas.

The inventive sealing composition preferably consists essentially, i.e., in particular more than 95% by weight, of:
at least one epoxy terminated polyurethane prepolymer (A);
heat-activatable curing agent or accelerator (B) comprising an amidoamine having a primary amino group and dicyanodiamide;
impact modifier (I) which is a reaction product of at least one polymeric diol, at least one polyisocyanate, and cardanol.
at least one polyaldimine (PA);
optionally filler (F);
reactive diluent (G) containing epoxy groups;
optionally plasticizer;
optionally catalyst (KA), which accelerates the hydrolysis of aldimino groups;
optionally catalyst (KN), which accelerates the reaction of isocyanate groups; and
optionally rheology modifier (R).

It is self-evident that in the polyurethane prepolymer (A), the heat-activatable curing agent or accelerator (B), the impact modifier (I), the polyaldimine (PA), the filler (F), the reactive diluent (G) containing epoxy groups, the plasticizer, catalyst (KA), catalyst (KN) and the rheology modifier (R) in the present invention are each different substances.

The sealing composition is prepared and stored in the absence of moisture. It is stable in storage, i.e., it can be stored for a period of several months or up to a year or even more in the absence of moisture in a suitable package or configuration, for example, a drum, a bag or a cartridge without any changes in application properties or in its properties after curing of an extent that would be relevant for use thereof. The storage stability is usually determined by measuring the viscosity.

The sealing composition is characterized by extraordinarily good storage stability. The change in viscosity of the sealing compound in an aluminum cartridge with an airtight seal after storage for 5 days at 60° C. in a circulating air oven can be used as a measure of long-term storage stability at room temperature. Experience has shown that at most a doubling of viscosity, i.e., an increase of max. 100%, is admissible for reliable use of the composition as a sealing compound. It has been found that the sealing compositions meet this requirement excellently; changes in viscosity amounting to less than 55% and in some cases even less than 35% can be achieved.

Very few blisters or none at all are formed during the curing of the sealing compositions according to the invention. Blisters are usually formed in air curing of polyisocyanates. Therefore, they have excellent mechanical properties and an optimal visual aspect. This is especially important because the CDC paint goes above the surface of the sealing compound and so the sealing compound surface can be seen through the CDC paint and/or the colored paint subsequently placed over it.

Furthermore, the sealing composition are largely elastic after being cured by heat and may have an extraordinarily good impact strength. This is especially advantageous in the case of seals that are exposed to impacts or movements during use.

This combination of advantageous properties makes it possible for the sealing compositions to be usable in particular as sealing compounds in autobody work, in particular in the engine space or for doors, trunk lids, tailgates or hoods.

In particular they may also be used as the sealing compound in flange fold seals, such as those disclosed in WO 2008/077918 A1.

In another aspect of the present invention, a method for sealing which comprises the following steps, is disclosed:
i) Applying a sealing composition, such as that described above, to a substrate(S), so that a portion of the surface of the sealing composition is in contact with air;
ii) Forming a skin on the surface of the sealing composition, which is in contact with the air;
iii) Heating the sealing composition to a temperature above 120° C., in particular between 160° C. and 220° C., to form a cured sealing composition.

Materials suitable for substrate(S) include in particular metals, in particular those metals which are used in the construction of vehicle bodies of automobiles in particular. These include in particular steels, especially electrolytically galvanized, flame galvanized, oiled steel, Bonazinc-coated steel and subsequently phosphatized steel, or aluminum, in particular in the variants that typically occur in automotive engineering. These include steel plates or aluminum plates in particular.

The application, i.e., the deposition, is preferably performed automatically and in particular in the form of a bead. However, the sealing compound composition may also be sprayed on. Other application methods such as swirl application, flat-stream spraying, mini-flat stream spraying and thin-stream spraying at speeds of >200 mm/s or the like are also conceivable. In addition, a manual application or manual reworking of the applied sealing compound composition by spatula or paintbrush is also possible.

Thus, in another aspect, the present invention also relates to a coated substrate obtained by applying a sealing composition such as that described in detail above to the surface of a substrate.

In an especially preferred embodiment, the sealing compound composition is applied to an oiled steel plate. The advantage of the composition that it adheres well to such a substrate and cures with very few blasters.

It is preferable for a step iia) to be performed between step ii) and step iii):

iia) Applying a paint, in particular a CDC paint, to the sealing composition.

Those skilled in the art of automotive engineering are extremely familiar with the concept of a CDC paint, which refers to a paint applied to sheet metal in a CDC bath (CDC=cathodic dip coating).

Step iii) is preferably performed in a CDC oven.

By heating the sealing composition, further curing takes place, so that the sealing composition receives its final strength.

The sealing composition is suitable for sealing gaps in particular.

It is thus preferable for the sealing composition to be applied in or to a gap in step i), said gap being bordered by two surfaces of the substrate(S) and a second substrate (S2), the second substrate (S2) being made of the same material as the substrate(S) or a different material.

Thus a sealed article is obtained by the method described above.

### EXAMPLES

The examples presented below serve only to illustrate the present invention.

Table 1 lists the raw materials that were used.

TABLE 1
Raw materials used.

| | |
|---|---|
| Prepolymer A | Epoxy- and NCO-terminated polyurethane; |
| | synthesis see below |
| Impact modifier I | Impact modifier; details see below |
| Curing accelerator | Amidoamine having a primary amino group |
| | (reaction product of phthalic anhydride and |
| | diethylene tetramine (TETA)) |
| Talc | Talcum filler |
| Chalk | Dried calcium carbonate filler |
| M570 | Carbon black, MONARCH ®570 Carbon |
| | Black (Cabot) |
| CaO | Calcium oxide |
| HDK H18 | Pyrogenic silica, HDK ® H18 (Wacker) |
| Dicyanex 1400F | Dicyanodiamide, Dicyanex ®1400F (Evonik) |
| 5% salicylic acid in DOA | Solution (5 wt.-%) of salicylic acid in dioctyl |
| | phthalate |
| Polyaldimine PA | Polyaldimine, latent hardener; details see below |

Part of additional raw materials for syntheses is as below

TABLE 2
Part of raw materials used for syntheses.

| | |
|---|---|
| D.E.R. ® 330 (bisphenol A diglycidyl ether = “DGEBA”) | Dow |
| Poly bd ® R-45HTLO (hydroxyl-terminated polybutadiene) | Arkema |
| (OH equivalent weight = approx. 1200 g/Eq) | |
| Isophorone diisocyanate (=“IPDI”) | Evonik |
| 1-Amino-3-aminomethyl-3,5,5-trimethyl cyclohexane | Evonik |
| (isophorone diamine = “IPDA”) | |

### Synthesis of Prepolymer A

417.5 g of Poly bd® R-45HTLO and 154.2 g of DGEBA were stirred together with 328.6 g of diisodecyl phthalate (DIDP) in vacuo at 80° C. A 0.8 g of catalyst solution (10% by weight dibutyltin dilaurate (DBTDL) in diisononyl phthalate) was added. Next, 98.9 g of IPDI was added while stirring and the mixture was stirred for 2 hours at 80° C. The premix of polyurethane polymer and epoxy resin thus formed had an NCO content of 1.6% by weight and an epoxy content of 0.82 mol Eq/kg.

### Synthesis of Impact Modifier I

A 1:1 (by weight) mixture of PolyTHF® 2000 (BASF) and Poly bd® R-45HTLO was reacted with IPDI (2 equivalents relative to the OH functions of the polyols) and subsequently the isocyanate groups of the thus obtained polymer were end-blocked by cardanol (trade name Cardolite® NC-700 (Cardolite)). The reaction was stopped as soon as free isocyanate was no longer detectable by IR spectroscopy (wavenumbers 2275-2230 cm-1).

### Synthesis of Polyaldimine PA

A round-bottom flask was charged with 14.55 g of IPDA under a nitrogen atmosphere. While stirring vigorously, 30.00 g of 2,2-dimethyl-3-(N-morpholino) propanal was added from a dropping funnel. Next, the volatile ingredients were removed in vacuo (10 mbar, 80° C.). Yield: 40.9 g of a clear, colorless oil having an amine content of 8.29 mmol N/g.

### Preparing Sealing Compositions

Using the ingredients indicated in parts by weight in Table 2, various sealing compositions were prepared in the absence of moisture. All ingredients were placed in three batches into a vacuum mixer at the room temperature under stirring with the speed of 200-300 rpm/min. The epoxy-terminated polyurethane and impact modifiers were placed in a first batch, and then the powdery material was placed in a second batch and finally the curing agents and liquids were added. The temperature was kept not to exceed 50° C. and the stirring was carried out for 40-50 min with the nitrogen introduced to break the vacuum.

After their preparation, the compositions were placed for 24 hours and then were used directly for testing. The mixture was cured at 180° C. for 30 min.

### Measurement Methods

The following properties of the compositions were measured:

### Elongation at Break and Tensile Strength

The elongation at break and tensile strength was measured mainly on basis of ISO 37 and ISO 527-2. Samples were prepared by making a 2 mm (+0.5 mm) thick sealant bubble-free sheet. They were cured and then stored for 2-6 hours at 23° C./50% RH. Afterward, at least five dumb-bells according to ISO 37 Type 2/ISO 527-2 Type 5A (chapter 6) were punched out of the sheet. The testing was carried out on them and the results was the average of at least five measurements.

### Viscosity

For the measurement of the viscosity of the composition, an Anton Paar rheometer MCR102 was used under a temperature rise from 20° C. to 70° C. at a rate of 10 K/min. The samples were measured at 23° C. (or 50° C., respectively), at a gap size of 1 mm and at a shear stress of 10 s-1.

### Skin Formation

To determine the skin formation time (“SFT”), the composition at room temperature was applied to cardboard in a layer thickness of approx. 3 mm and the time until no residues of composition remained on the pipette for the first time when tapping lightly on the surface of the composition by means of a pipette made of LDPE, was determined in a standard atmosphere (STP; 23±1° C., 50±5% relative humidity).

### Extrusion Force

For the determination of the extrusion force, the compositions were dispensed into internally coated aluminum cartridges (outer diameter 46.9 mm, inner diameter 46.2 mm, length 215 mm, metric ISO thread M15×1.5 mm) and given an airtight seal with a polyethylene stopper (diameter 46.1 mm) from Novelis Deutschland GmbH. After conditioning at 23° C. for 24 hours, the cartridges were opened and the contents extruded using an extrusion device. For this purpose, a nozzle with a 5 mm inside-diameter opening was screwed onto the cartridge thread. Using an extrusion device (Zwick/Roell Z005), a determination was made of the force needed to extrude the composition at an extrusion rate of 60 mm/min. The figure reported is an average value of the forces measured after an extrusion distance of 22 mm, 24 mm, 26 mm, and 28 mm. After an extrusion distance of 30 mm, measurement was halted.

### Blistering (Bubble in Bead)

The triangular beads of the composition were applied onto the metal tile so as to prepare the samples. After storage at room temperature for one day, they were then placed in the convection oven at the elevated temperature 180° C. for 30 mins to cure thoroughly. The sample was placed under air exhaust. The beads were then cut with a cutter parallel to the substrate along the direction of application. Check visually if the bubbles were visible. “No” means no bubbles are visible.

### Lap-Shear Strength

The 2 mm lap-shear strength was measured on the oiled hot-dip galvanized steel plate according to ISO 4587. With the inventive composition, a 100% CF (cohesive failure) was achieved on the substrate.

### Sag Resistance

A piece of cardboard was placed in a fully upright position. A 15 cm long triangular bead with the size of 8 mm×10 mm was carefully applied on the cardboard and kept in this position for at least 2-3 minutes. Then its appearance was rated according to the following scale:

| | |
|---|---|
| 1 - Excellent | Tip did not move |
| 2 - Good | Tip between center and base axis |
| 3 - Fair | Tip at the height of base axis |
| 4 - Poor | Tip below base axis |
| 5 - Bad | No tip |

TABLE 3
Compositions and properties.

| | 1* | 2* | 3* | 4* | 5 | 6 | 7 | 8 | 9 | 10 | 11 |
|---|---|---|---|---|---|---|---|---|---|---|---|
| Component | Percentage % | | | | | | | | | | |
| Prepolymer A | 48.00 | 48.00 | 48.00 | 48.00 | 48.00 | 48.00 | 48.00 | 48.00 | 48.00 | 48.00 | 48.00 |
| Impact modifier I | — | 20.00 | 10.00 | 5.00 | 5.00 | 5.00 | 5.00 | 5.00 | 5.00 | 5.00 | 5.00 |
| Curing accelerator | 2.70 | 2.70 | 2.70 | 2.70 | 2.70 | 2.70 | 2.70 | 2.70 | 2.70 | 0.80 | 3.50 |
| Talc | 16.65 | 6.65 | 11.65 | 14.15 | 14.05 | 14.05 | 14.05 | 14.05 | 14.05 | 14.05 | 14.05 |
| Chalk | 16.65 | 6.65 | 11.65 | 14.15 | 14.15 | 14.15 | 14.15 | 14.15 | 14.15 | 14.15 | 14.15 |
| M570 | 0.50 | 0.50 | 0.50 | 0.50 | 0.50 | 0.50 | 0.50 | 0.50 | 0.50 | 0.50 | 0.50 |
| CaO | 5.00 | 5.00 | 5.00 | 5.00 | 5.00 | 5.00 | 5.00 | 5.00 | 5.00 | 5.00 | 5.00 |
| HDK H18 | 5.00 | 5.00 | 5.00 | 5.00 | 5.00 | 5.00 | 5.00 | 5.00 | 5.00 | 5.00 | 5.00 |
| Dicyanex 1400F | — | — | — | — | 0.10 | 0.20 | 0.30 | 0.60 | 1.00 | 0.20 | 0.20 |
| 5% salicylic acid in DOA | 2.00 | 2.00 | 2.00 | 2.00 | 2.00 | 2.00 | 2.00 | 2.00 | 2.00 | 2.00 | 2.00 |
| Polyaldimine PA | 3.50 | 3.50 | 3.50 | 3.50 | 3.50 | 3.50 | 3.50 | 3.50 | 3.50 | 3.50 | 3.50 |

Properties

| | | | | | | | | | | | |
|---|---|---|---|---|---|---|---|---|---|---|---|
| Elongation at break | — | — | — | — | 325% | 295% | 230% | 163% | 71% | 105% | 210% |
| Tensile strength / MPa | 1.92 | 1.98 | 2.10 | 2.06 | 2.44 | 2.54 | 2.77 | 3.17 | 3.68 | 1.55 | 2.78 |
| Skin time | — | — | — | — | 4 h | 4 h | 4 h | 4 h | — | — | — |
| Lap shear / MPa | — | — | — | — | 1.78 | 2.16 | 2.27 | 2.30 | 2.50 | 0.90 | 1.40 |
| Extrusion force / N | — | — | — | — | 344 | 343 | 341 | 348 | — | — | — |
| Bubble in bead | — | — | — | — | No | No | No | No | — | — | — |
| Viscosity @25° C. / Pa · s | — | — | — | — | 401 | 404 | 406 | 416 | — | — | — |
| Viscosity @50° C. / Pa · s | — | — | — | — | 166 | 168 | 171 | 172 | — | — | — |
| Sag resistance | — | — | — | — | 2-3 | 2-3 | 2-3 | 2-3 | — | — | — |

“—”: not determined.
*not according to the invention

1. A sealing composition, comprising:
at least one epoxy terminated polyurethane prepolymer; heat-activatable curing agent or accelerator comprising an amidoamine having a primary amino group and dicyanodiamide;
impact modifier which is a reaction product of at least one polymeric diol, at least one polyisocyanate, and cardanol; and
at least one polyaldimine.

2. The sealing composition according to claim 1, wherein the epoxy terminated polyurethane prepolymer is an isocyanate group containing polyurethane prepolymer which is partly terminated by the epoxide and has a certain content of free isocyanate group, based on the total weight of the polyurethane prepolymer.

3. The sealing composition according to claim 1, wherein the epoxy terminated polyurethane prepolymer is represented by the following formula (IVa): 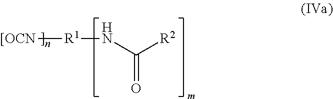
where R¹ is a linear or branched polyurethane prepolymer PU1 terminated by n+m isocyanate groups, after removal of all of the terminal isocyanate groups;
each R², independently of the others, is a group of the formula (II) 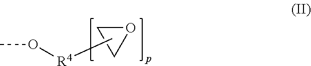
where in each case R⁴ is a moiety of an aliphatic, cycloaliphatic, aromatic, or araliphatic epoxide containing a primary or secondary hydroxy group, after the removal of
the hydroxide and epoxide groups;
p=1, 2, or 3;
each of n and m is a value from 1 to 7, with the proviso that 2≤(m+n)≤8.

4. The sealing composition according to claim 1, wherein the polyaldimine is present in an amount in the sealing compound composition, such that the ratio of the number of aldimino groups to the number of isocyanate groups has a value of 0.2 to 0.8.

5. The sealing composition according to claim 1, wherein the heat-activatable curing agent or accelerator (B) comprises 1.0-3.3 wt %, based on the total weight of the sealing composition.

6. The sealing composition according to claim 1, wherein the amidoamine having a primary amino group is the one that is obtained by the reaction of phthalic anhydride and a polyamine having primary amino groups.

7. The sealing composition according to claim 1, wherein the impact modifier is contained in an amount of 1-25 wt %, based on the total weight of the sealing composition.

8. The sealing composition according to claim 1, wherein the impact modifier I is a polymer of the formula (IV), 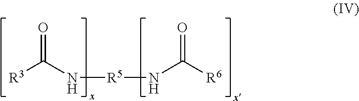
wherein, x and x′ independently of one another are each values of 0 or 1;
R⁵ is a linear polyurethane prepolymer containing at least x+x′ terminal isocyanate groups, after removal of x+x′ terminal isocyanate groups;
R⁶ and R³ are residues of cardanol after removal of the hydroxyl H atom and are bonded via the oxygen atom.

9. The sealing composition according to claim 1, wherein the sealing composition additionally contains carbon black or other electrically conductive additives.

10. A coated substrate obtained by applying a sealing composition according to claim 1, to the surface of a substrate.

11. A method for sealing, comprising the steps of
i) applying a sealing composition according to claim 1 to a substrate, so that a portion of the surface of the sealing compound composition is in contact with air;
ii) forming a skin on the surface of the sealing composition which is in contact with the air;
iii) heating the sealing compound composition to a temperature of more than 120° C., forming a fully cured sealing composition.

12. The method for sealing according to claim 11, wherein a step iia) is performed between steps ii) and iii):
iia) applying a paint to the sealing composition.

13. The method according to claim 11, wherein step iii) is performed in a CDC oven.

14. The method according to claim 11, wherein the sealing composition in step i) is applied to or into a gap, which is bordered by two surfaces of the substrate and the second substrate, the second substrate being made of the same material as the substrate or a different material.

15. A sealed article obtained by a method according to claim 11.
